(19) United States
(12) Patent Application Publication
(10) Pub. No.: US 2023/0365348 A1
(43) Pub. Date: Nov. 16, 2023

(54) BOTTLE GRIPPING ASSEMBLY

(71) Applicant: AMTIG ENGINEERING SOLUTIONS, LLC, Quincy, MI (US)

(72) Inventor: Steven GROHOLSKI, Quincy, MI (US)

(21) Appl. No.: 17/743,960

(22) Filed: May 13, 2022

(51) Int. Cl. B65G 47/86

(52) U.S. Cl. CPC B65G 47/847; B65G 2201/0247

(57) ABSTRACT

A bottle gripping assembly kit including a bottle gripping finger assembly having bottle grip arms and an actuator for actuating the bottle gripping finger assembly for selectively grabbing and releasing a bottle. The actuator including a plurality of actuator heads and a base, wherein a selected one of the actuator heads can be connected to the base dependent on the size of the bottle. The plurality of actuator heads each have engagement surfaces adapted to abut the bottle grip arms to force the first ends of the bottle grip arms towards each other. Each of the actuator heads has a distance between the engagement surfaces that is different than a distance between the engagement surfaces of the remaining actuator heads, thereby allowing the selected one of the actuator heads to be selected depending on the size of the bottle.

### FIELD OF THE INVENTION

The present invention relates to bottling, and in particular to an improved bottle gripping assembly.

### BACKGROUND OF THE INVENTION

Conveyor systems have been developed for quickly filling and capping a multitude of bottles in a very short period of time. The conveyor systems move empty and uncapped bottles along a line and/or along a periphery of a wheel and fill the bottles (with, for example, water, soda or any other liquid) and cap the bottles while the bottles continuously move.

FIGS. 1A and 1B illustrate a prior art bottle gripping finger assembly 10. The prior art bottle gripping finger assembly 10 includes a pair of grip arms 12 that grip the bottle 60 as the bottle 60 is moved about the periphery of a wheel 62 (see FIG. 2A). The prior art bottle gripping finger assembly 10 includes a base plate 14 for holding the grip arms 12. The base plate 14 can be a part of the wheel 62 of the conveyor system or can be connected to the wheel 62. The base plate 14 includes a rear wide portion 16 having a central actuator opening 18. The rear wide portion 16 of the base plate 14 is also shown as including a plurality of fastener openings 20 for accepting fasteners 64 therethrough for connecting the base plate 14 to the wheel 62 of the conveyor system. The base plate 14 also includes a front narrow support portion 22 with a pair of bolt openings (not shown).

The grip arms 12 of the prior art bottle gripping finger assembly 10 are actuated to selectively grip and hold the bottles 60. The grip arms 12 are mirror images of each other such that only one grip arm 12 will be discussed, with the understanding that the other grip arm 12 has the same features in reverse. The grip arm 12 includes a main section 24 that tapers toward the rear of the grip arm 12. The main section 24 includes an inwardly facing C-shaped rear recess 26 having a pair of end fingers 28 that extend toward each other and that each define a spring receiving slot 30. A vertically oriented leaf spring 32 is located within the inwardly facing C-shaped rear recess 26, with ends of the vertically oriented leaf spring 32 being located within the spring receiving slots 30. A middle area of the main section 24 includes a bolt hole (not shown). A front area of the main section 24 includes an inwardly facing spring recess 34. As illustrated in FIG. 1A, a spring 36 extends between the inwardly facing spring recesses 34 of the grip arms 12, with ends of the spring 36 being located within facing spring receiving bores (not shown). The grip arm 12 also includes a front curved grip member 38 having an arcuate inner face 40. A plurality of support lips 42 extend inwardly from the arcuate inner face 40.

A top holder bracket 44 and a pair of bolts 52 connect the grip arms 12 to the base plate 14. The top holder bracket 44 is substantially rectangular and includes a T-shaped opening 46 as viewed from the top (FIG. 1A). A rear portion of the top holder bracket 44 outside of the T-shaped opening 46 defines a support bar 48. Front panels 50 on either side of the base of the T-shaped opening 46 have bolt holes (not shown). The bolts 52 have heads 54 that rest on the top of the front panels 50. Threaded post portions 58 of the bolts 52 extend through the bolt holes in the front panels 50 of the top holder bracket 44, through the bolt holes in the middle area of the main section 24 of the grip arms 12 and into the bolt openings (which are internally threaded) in the front narrow support portion 22 of the base plate 14.

FIG. 1A illustrates the prior art bottle gripping finger assembly 10 in a bottle receiving position. As illustrated in FIG. 1A, an actuator head 56 extends through the actuator opening 18 of the rear wide portion 16 of the base plate 14 and is located between the leaf springs 32 of the grip arms 12. When the actuator head 56 does not abut the leaf springs 32 (as shown), the spring 36 forces the front curved grip members 38 of the grip arms 12 away from each other about the threaded post portions 58 of the bolts 52. However, when an upper portion of the bottle is inserted into the area 59 between the front curved grip members 38 of the grip arms 12, the actuator head 56 is rotated by 90° to press against the leaf springs 32, thereby forcing the rear area of the main section 24 of the grip arms 12 away from each other about the threaded post portions 58 of the bolts 52, such that the front curved grip members 38 of the grip arms 12 move toward each other and capture the top portion of the bottle within the area 59 between the front curved grip members 38 of the grip arms 12 and the support lips 42 being located below a ring of the bottle.

FIG. 2B illustrates the prior art bottle gripping finger assembly 10 (open), 10′ (closed) on the wheel 62 of the conveyor system as is well known to those skilled in the art. As shown in FIG. 2B, a plurality of fasteners 64 extend through the fastener openings 20 of the base plate 14 to connect each of the prior art bottle gripping finger assembly 10 to the wheel 62.

During use of the prior art bottle gripping finger assembly 10, the actuator head 56 can be actuated to move the grip arms 12 to grip the bottle 60 as outlined above, with the support lips 42 of the grip arms 12 supporting a top ring 68 of the bottle 60 located below a threaded cylinder 70 of the bottle 60 as shown in FIG. 2A. As shown in FIG. 2B, when the prior art bottle gripping finger assembly 10 is in an open position, the actuator head 56 does not engage the vertically oriented leaf spring 32. In the open position, the prior art bottle gripping finger assembly 10 does not hold the bottle 60 as shown in FIG. 2A. However, when the actuator head 56 rotates against the vertically oriented leaf spring 32 of the prior art bottle gripping finger assembly 10′ as shown in FIG. 2B, the prior art bottle gripping finger assembly 10′ moves to the closed position to hold the bottle 60 as shown in FIG. 2A. While FIG. 2A illustrates the prior art bottle gripping finger assembly 10 with support lips 42 that grab below the top ring 68, the support lips 42 can also be configured to grab the threads 72 on the threaded cylinder 70.

FIG. 3 illustrates a prior art actuator 74 having the actuator head 56. The prior art actuator 74 includes a substantially triangular base portion 76, a cylinder 78 extending from a top surface 80 of the substantially triangular base portion 76, and the actuator head 56 extending from the cylinder 78. The substantially triangular base portion 76 includes a long, flat side surface 82 and a pair of curved side surfaces 84. The pair of curved side surfaces 84 meet at a substantially round intersection (not shown). During rotation of the wheel 62, ends of the long, flat side surface 82 are abutted to rotate the substantially triangular base portion 76 about the substantially round intersection, thereby rotating the actuator head 56 to open and close the prior art bottle gripping finger assembly 10 to grab and release the bottle 60.

In the prior art bottle gripping finger assembly 10, the vertically oriented leaf springs 32 flex and allow the prior art bottle gripping finger assembly 10 to be used with bottles 60 having different diameter necks, thereby allowing the prior art bottle gripping finger assembly 10 to be used in multiple systems having different size bottles 60.

### SUMMARY OF THE INVENTION

The present invention, according to one aspect, is directed to a bottle gripping assembly comprising a bottle gripping finger assembly and an actuator for actuating the bottle gripping finger assembly for selectively grabbing and releasing a bottle. The bottle gripping finger assembly includes a base with a pair of grip arms rotatably connected to the base. The bottle gripping finger assembly includes a biasing element forcing first ends of the grip arms away from each other. The actuator includes an actuator head configured to abut each of the grip arms to force the first ends of the grip arms towards each other against the bias of the biasing element to thereby actuate the bottle gripping finger assembly for selectively grabbing the bottle. The actuator head is configured to be rotated to allow the biasing element to force the first ends of the grip arms away from each other to thereby release the bottle. The actuator head includes a pair of rollers, with each of the rollers configured to abut against the grip arms to force the first ends of the grip arms towards each other against the bias of the biasing element.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1A is a top view of a prior art bottle gripping finger assembly.

FIG. 1B is a side view of the prior art bottle gripping finger assembly.

FIG. 2A is a side view of a prior art bottle gripping finger assembly holding a bottle.

FIG. 2B is a top view of multiple prior art bottle gripping finger assemblies on a filling wheel.

FIG. 3 is a perspective view of a prior art actuator.

FIG. 4 is an exploded perspective view of a bottle gripping assembly of the present invention.

FIG. 5A is a top view of the bottle gripping assembly of the present invention in an unclamped position.

FIG. 5B is a top view of the bottle gripping assembly of the present invention in a clamped position.

FIG. 6 is a side view of the bottle gripping assembly of the present invention.

FIG. 7 is a cross-sectional view of the bottle gripping assembly of the present invention taken along the line VII-VII of FIG. 5A.

FIG. 8 is an end view of the bottle gripping assembly of the present invention.

FIG. 9 is a perspective view of an actuator of the present invention.

FIG. 10 is a top view of the actuator of the present invention.

FIG. 11 is a side view of the actuator of the present invention.

FIG. 12 is a cross-sectional view of the actuator of the present invention taken along the line XII-XII of FIG. 11.

FIG. 13 is a perspective view of a base of the actuator of the present invention.

FIG. 14 is a top view of the base of the actuator of the present invention.

FIG. 15 is a bottom view of the base of the actuator of the present invention.

FIG. 16 is an end view of the base of the actuator of the present invention.

FIG. 17 is a side view of the base of the actuator of the present invention.

FIG. 18 is a cross-sectional view of the base of the actuator of the present invention taken along the line XVIII-XVIII of FIG. 14.

FIG. 19 is a perspective view of a holder of the actuator of the present invention.

FIG. 20 is a side view of the holder of the actuator of the present invention.

FIG. 21 is an end view of the holder of the actuator of the present invention.

FIG. 22 is a top view of the holder of the actuator of the present invention.

FIG. 23 is a top view of a top cap of the actuator of the present invention.

FIG. 24 is a side view of a top cap of the actuator of the present invention.

FIG. 25 is a top view of a roller of the actuator of the present invention.

FIG. 26 is a cross-sectional view of the roller of the actuator of the present invention taken along the line XXVI-XXVI of FIG. 25.

FIG. 27 is a schematic representation of a system for selecting an actuator for various bottle sizes.

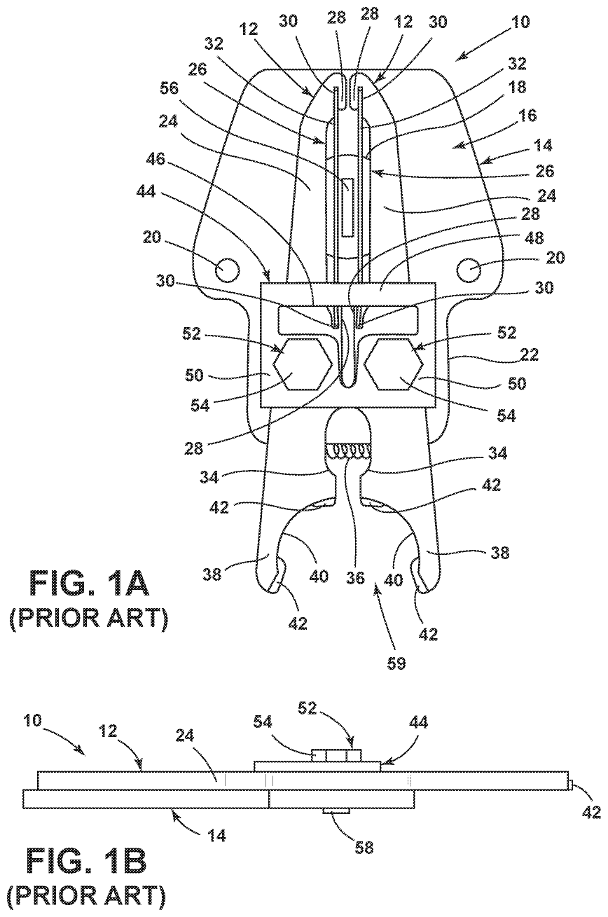

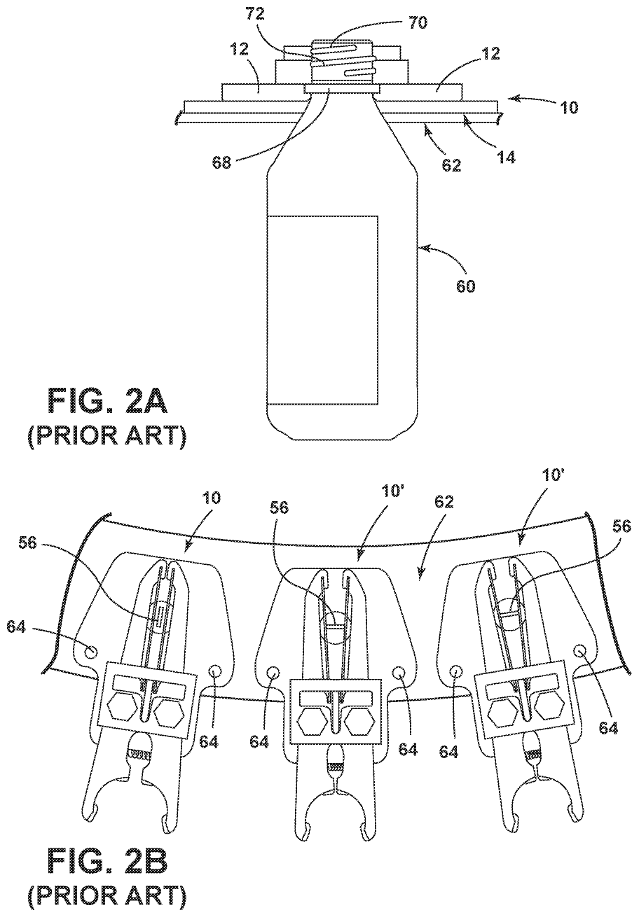

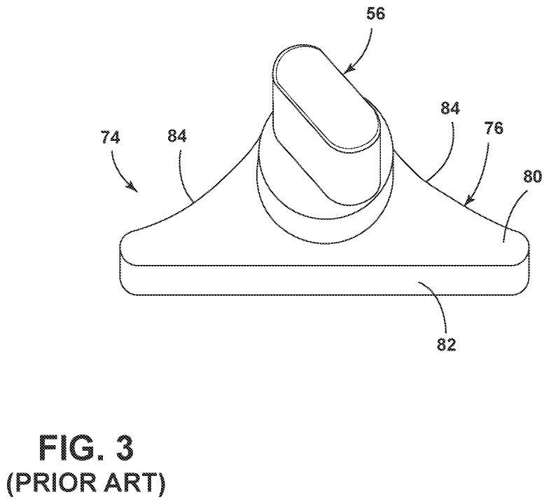

The specific devices and processes illustrated in the attached drawings and described in the following specification are simply exemplary embodiments of the inventive concepts. Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

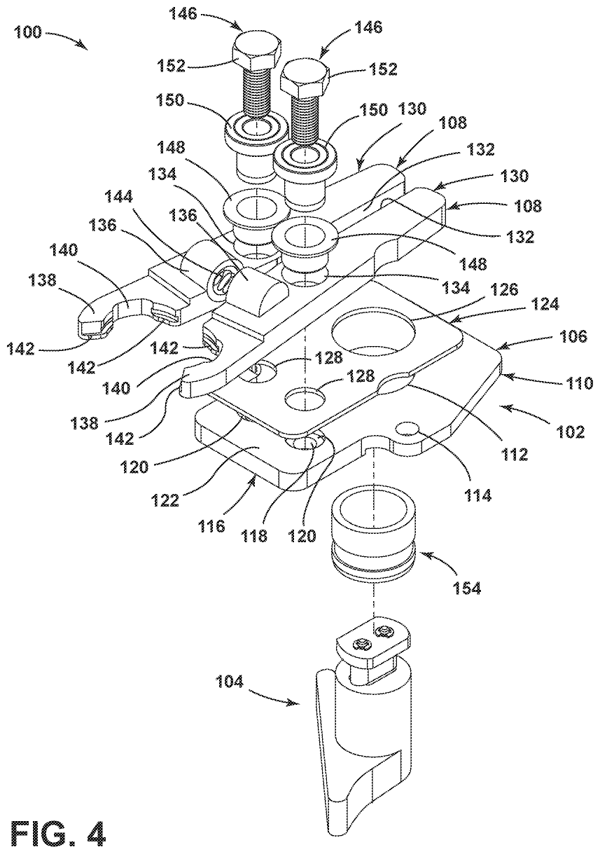

The reference number 100 (FIG. 4) generally designates a bottle gripping assembly of the present invention. The bottle gripping assembly 100 includes a bottle gripping finger assembly 102 and an actuator 104. The bottle gripping finger assembly 102 can be as shown in FIG. 4. Furthermore, the bottle gripping finger assembly 102 can be the prior art bottle gripping finger assembly 10 or can be the inventive bottle gripping assembly as disclosed in U.S. Pat. No. 11 224 974 entitled BOTTLE GRIPPING ASSEMBLY, the entire contents of which is hereby incorporated herein by reference, except with the change that the grip arms 12 do not include any inwardly facing C-shaped rear recesses 26 or vertically oriented leaf springs 32.

The illustrated bottle gripping finger assembly 102 includes a base plate 106 for holding grip arms 108. The base plate 106 includes a rear wide portion 110 having a central actuator opening 112. The rear wide portion 110 of the base plate 106 is also shown as including a plurality of fastener openings 114 for accepting fasteners therethrough for connecting the base plate 106 to the wheel 62 of the conveyor system. The base plate 106 also includes a front narrow support portion 116 with a pair of inner threaded bolt openings 118 at the bottom of a counterbore 120 in a top surface 122 thereof. A wear pad 124 has a rear opening 126 aligned with the central actuator opening 112 and a pair of front openings 128 aligned with the counterbores 120. The wear pad 124 is positioned between the top surface 122 of the base plate 106 and the grim arms 108.

In the illustrated example, the grip arms 108 of the bottle gripping finger assembly 102 are actuated to selectively grip and hold the bottles 60. The grip arms 108 are mirror images of each other such that only one grip arm 108 will be discussed, with the understanding that the other grip arm 108 has the same features in reverse. The grip arm 108 includes a main section 130 having an inwardly facing abutment surface 132, a vertically orientated bushing opening 134, an inwardly facing spring cylinder 136, and a front curved grip member 138 having an arcuate inner face 140. A spring 144 extends between the inwardly facing spring cylinders 136 of the grip arms 108, with ends of the spring 144 being located within inwardly facing spring cylinders 136. A plurality of support lips 142 extend inwardly from the arcuate inner face 140 for holding a bottle 60 as is well known to those skilled in the art.

The illustrated grip arms 108 are connected to the base plate 106 by fastener assemblies 146. Each fastener assembly 146 includes an inner bushing 148, a wear bushing 150, and a fastener 152. The inner bushing 148 extends through the vertically orientated bushing opening 134 in the main section 130 of the grip arm 108. The wear bushing 150 extends through the inner bushing 148 and into the counterbore 120 in the top surface 122 in the front narrow support portion 116 of the base plate 106. The fastener 152 extends through the wear bushing 150 and into the inner threaded bolt opening 118 to connect the fastener assembly 146 and thereby the grip arms 108 to the base plate 106.

In the illustrated example, the bottle gripping finger assembly 102 can include a receiving cylinder 154 for aligning the actuator 104 with the bottle gripping finger assembly 102. The receiving cylinder 154 fits within the central actuator opening 112 of the rear wide portion 110 of the base plate 106. The receiving cylinder 154 can be fastened to the base plate 106 by an adhesive, welding or other similar manner of connecting two parts. It is also contemplated that the receiving cylinder 154 could fit within the central actuator opening 112 with an interference fit. Moreover, it is contemplated that the receiving cylinder 154 could abut a bottom of the base plate 106 and be aligned with the central actuator opening 112 of the rear wide portion 110 of the base plate 106, with the outer diameter of the receiving cylinder 154 being larger than the central actuator opening 112 in this case.

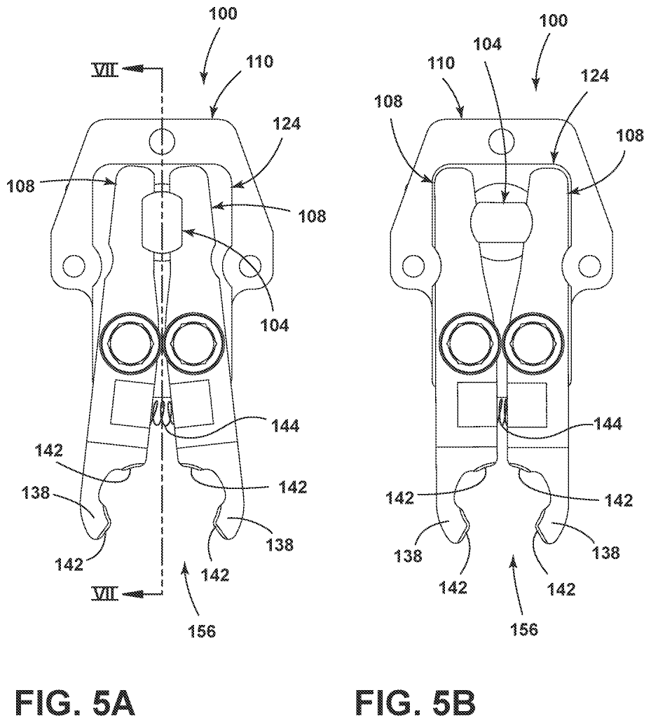

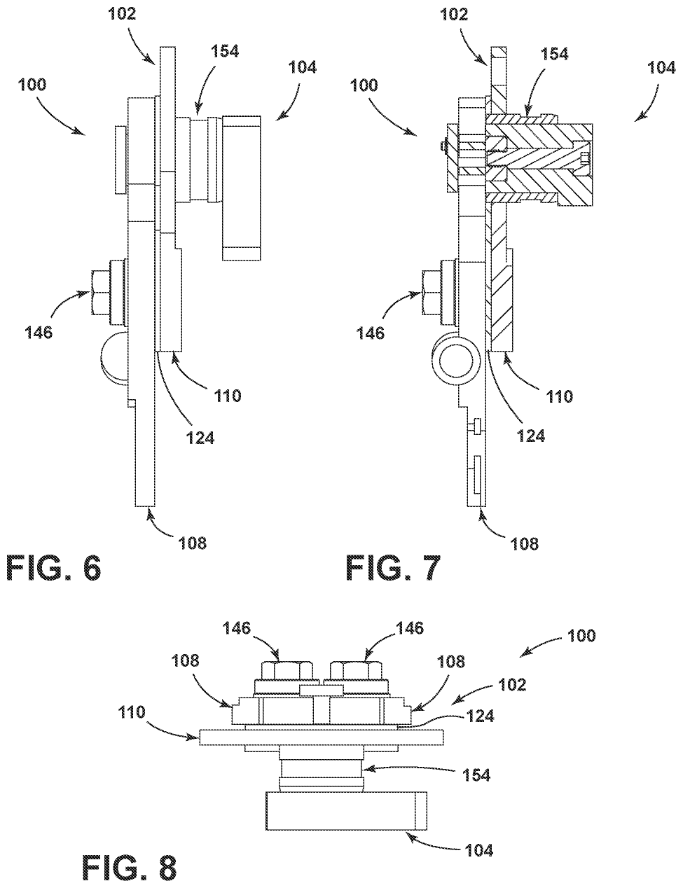

The illustrated actuator 104 is configured to be rotated as does the prior art actuator 74 to move the bottle gripping finger assembly 102 between an open position as illustrated in FIG. 5A wherein a bottle 60 can be received within an area 156 between the front curved grip members 138 of the grip arms 108 and a closed position as illustrated in FIG. 5B wherein a bottle 60 can be received within the area 156 between the front curved grip members 138 of the grip arms 108 to be held by the support lips 142. While FIGS. 4-6 illustrate the bottle gripping finger assembly 102 with support lips 142 that grab below the top ring 68 of the bottle 60, the front curved grip members 138 would have support lips 42 configured to grab the threads 72 on the threaded cylinder 70 or not have support lips 42, but still be able to grip a bottle 60.

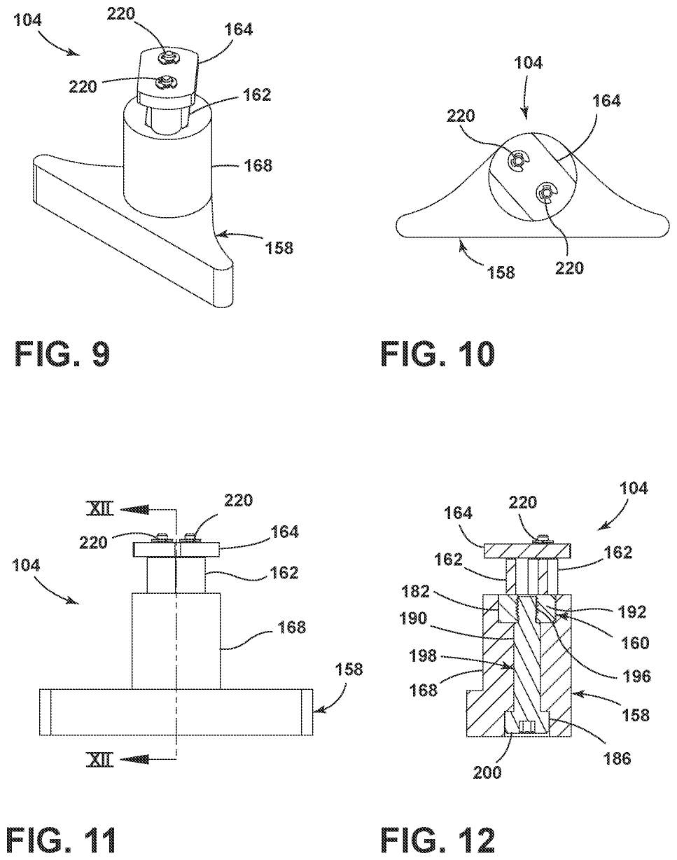

In the illustrated example, the actuator 104 (FIGS. 9-12) moves easily within the receiving cylinder 154 and the bottle gripping finger assembly 102 to open and close the bottle gripping finger assembly 102. The actuator 104 includes a base 158, a holder 160, a pair of rollers 162 and a top cap 164. The holder 160 rests withing the base 158 and the pair of rollers 162 are connected to the holder 160. The top cap 164 maintains the rollers 162 on the holder 160.

The illustrated base 158 of the actuator 104 is shaped and configured to move in the same manner of the prior art base of the prior art actuator as outlined above. The base 158 includes a substantially triangular main portion 166 and a cylinder 168 extending from a top surface 170 of the substantially triangular main portion 166. The substantially triangular main portion 166 includes a long, flat side surface 172 and a pair of concave curved side surfaces 174. The pair of concave curved side surfaces 174 meet at a substantially round intersection 176. During rotation of the wheel 62, ends of the long, flat side surface 172 are abutted to rotate the substantially triangular main portion 166 about the substantially round intersection 176, thereby rotating the actuator 104 to open and close the bottle gripping finger assembly 102 to grab and release the bottle 60.

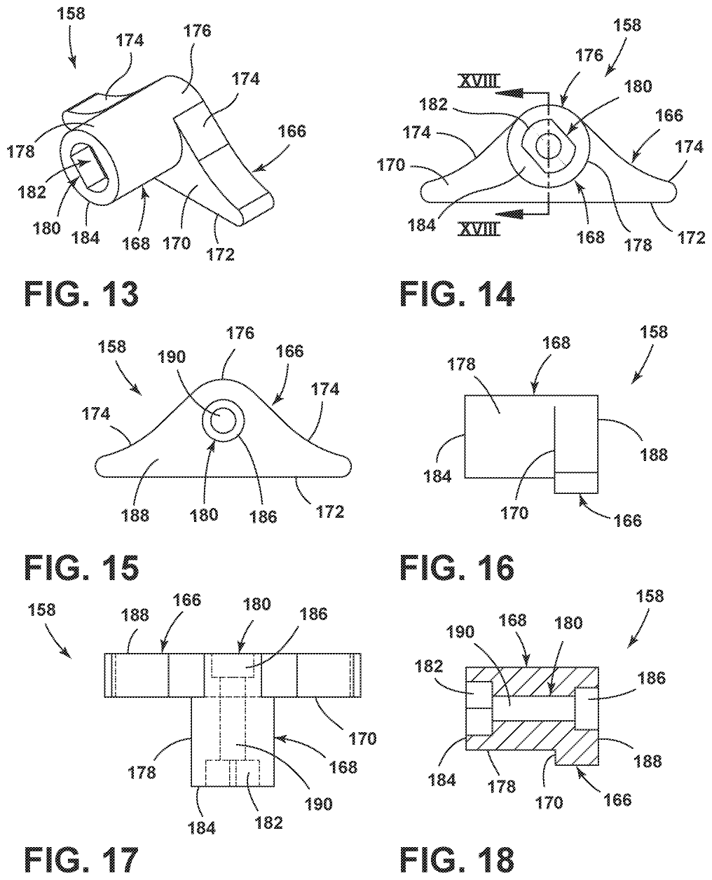

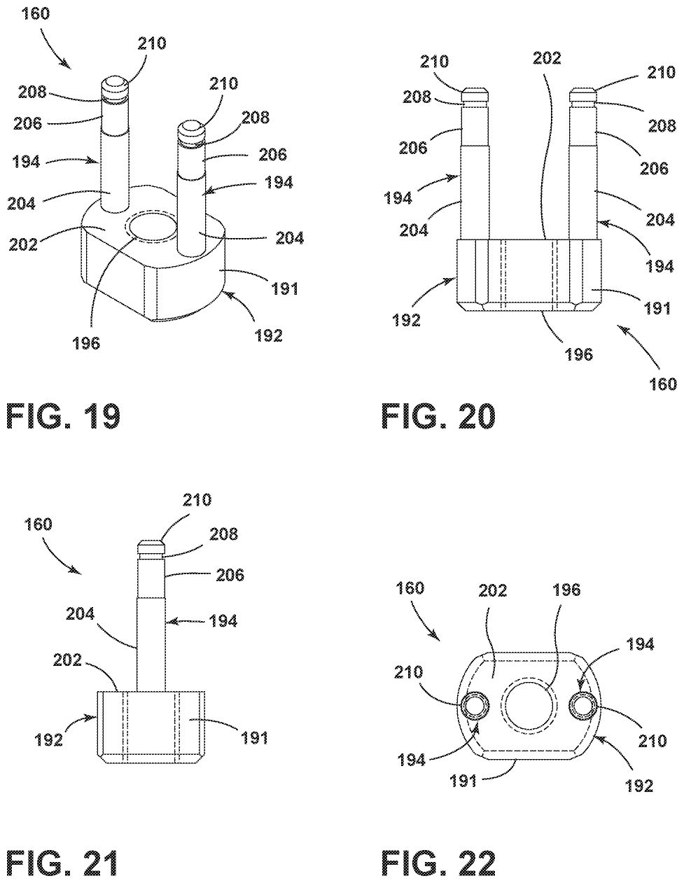

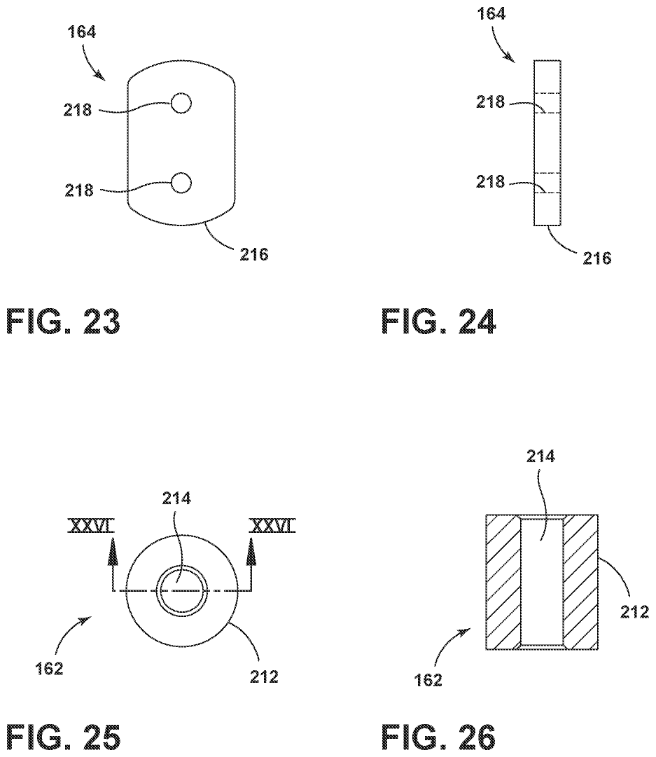

In the illustrated example, the cylinder 168 of the base 158 of the actuator 104 is configured to receive the holder 160. The cylinder 168 includes an outside surface 178 coextensive with the substantially round intersection 176 as shown in FIGS. 13 and 14. The cylinder 168 includes a stepped opening 180 therethrough. The stepped opening 180 includes a first counterbore 182 located in a top 184 of the cylinder 168 opposite the substantially triangular main portion 166. The first counterbore 182 is non-circular (e.g., oval as shown). The first counterbore 182 is configured to receive the holder 160 therein. The stepped opening 180 also includes a second counterbore 186 located at a bottom surface 188 of the substantially triangular main portion 166. A fastener hole 190 extends between the first counterbore 182 and the second counterbore 186.

The illustrated holder 160 is positioned within the first counterbore 182 of the cylinder 168 of the base 158 of the actuator 104 and rotates with the base 158. The holder 160 includes a pedestal 192 and a pair of posts 194. The pedestal 192 has a non-circular outer side surface 191 that corresponds to the shape of the first counterbore 182. As shown in FIG. 12, the pedestal 192 of the holder 160 rests within the first counterbore 182 of the cylinder 168 of the base 158. The pedestal 192 includes an inner threaded hole 196 that aligns with the stepped opening 180 in the cylinder 168. As shown in FIG. 12, a fastener 198 extends through the stepped opening 180 in the cylinder 168 and into the inner threaded hole 196 of the pedestal 192 of the holder 160. The holder 160 is connected to the base 158 by threading the fastener 198 into the inner threaded hole 196 of the pedestal 192 of the holder 160, with an enlarged head 200 of the fastener 198 being received within the second counterbore 186 of the stepped opening 180 in the cylinder 168.

In the illustrated example, the posts 194 of the holder 160 are configured to hold the rollers 162 and the top cap 164. The posts 194 are parallel and extend upwardly from a top surface 202 of the pedestal 192 away from the base 158. Each post 194 includes, moving upward from the top surface 202 of the pedestal 192, a large diameter roller receiving cylindrical area 204, a small diameter top cap receiving cylindrical area 206, a clip channel 208 and a head 210.

The illustrated rollers 162 (FIGS. 25-26) are configured to fit over and roll on the posts 194 of the holder 160. Each roller 162 is a cylinder 212 having an inner opening 214 for receiving the post 194 therein. The inner opening 214 is configured to be slightly larger than the large diameter roller receiving cylindrical area 204 of the posts 194 of the holder 160. Each roller 162 also has about the same height as the large diameter roller receiving cylindrical area 204 as shown in FIGS. 9, 11 and 12. The rollers 162 are configured to easily rotate on the posts 194.

In the illustrated example, the top cap 164 keeps the rollers 162 on the posts 194 of the holder 160. The top cap 164 is a plate 216 with a pair of holes 218 therethrough. The top cap 164 fits over the heads 210 of the posts 194 of the holder 160 and onto the small diameter top cap receiving cylindrical area 206 of the posts 194. As shown in FIGS. 9-12, C-shaped clips 220 snap into the clip channel 208 of the posts 194 to hold the top cap 164 on the posts 194. It is contemplated that the clips 220 can be welded or otherwise solidly connected to the posts 194 (with the posts 194 still including the heads 210 or without the heads 210). It is further contemplated that the top cap 164 could be a pair of top caps 164, one for each post 194. Likewise, the top cap 164 for each post could perform the same function as the clips 220 such that the top cap 164 is also a clip 220, thereby removing the need for an extra clip. In this situation, the top cap 164 can be welded or otherwise solidly connected to the posts 194 (with the posts 194 still including the heads 210 or without the heads 210).

The prior art bottle gripping finger assemblies 10 and associated prior art actuators 74 that have the actuator head 56 always applied the same forces to the vertically oriented leaf springs 32 of the prior art bottle gripping finger assemblies 10. Therefore, if the size of the neck located below the top ring 68 of the bottle 60 and/or the threaded cylinder 70 of the bottle 60 at different bottling systems have different sizes, the bottle 60 could either be held not securely enough or could be held too tightly, thereby deforming the bottle 60. In either situation, the result could be costly downtime of the bottling system.

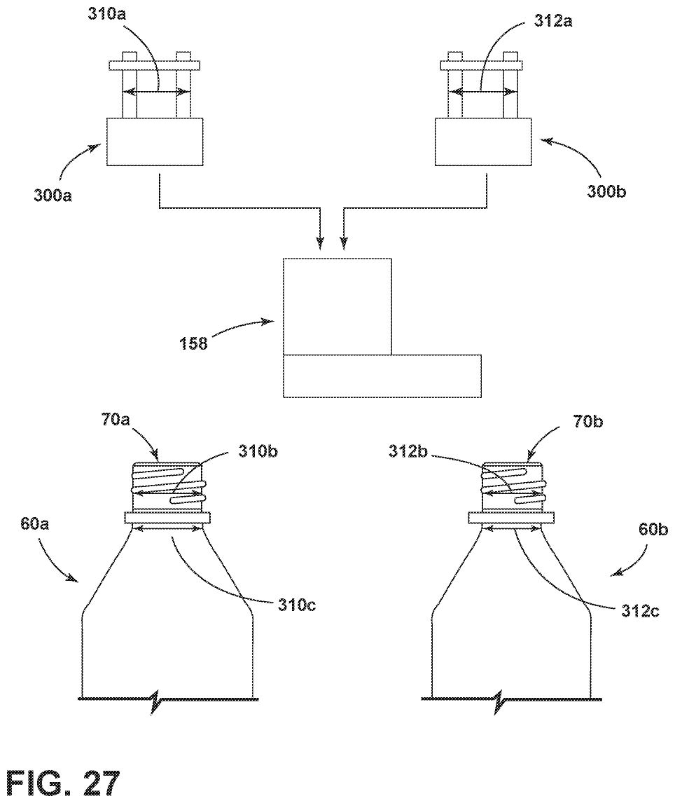

The bottle gripping assembly 100 of the present invention allows for securely grabbing and holding any bottle 60 and can be used with bottles 60 of different sizes. As shown in FIG. 27, a first actuator head 300a comprising the holder 160, the pair of rollers 162 and the top cap 164 (if employed) can have a first distance 310a between the outer periphery of the rollers 162. A second actuator head 300b comprising the holder 160, the pair of rollers 162 and the top cap 164 (if employed) can have a second distance 312a between the outer periphery of the rollers 162. The first distance 310a can be a little longer than the second distance 312a. During assembly of the bottling system, the first actuator head 300a can be positioned within the base 158 if a first bottle 60a having a first corresponding size 310b of the threaded cylinder 70 or a first corresponding size 310c of the neck located below the top ring 68 of the first bottle 60a. Likewise, the second actuator head 300b can be positioned within the base 158 if a second bottle 60b having a second corresponding size 312b of the threaded cylinder 70 or a first corresponding size 310c of the neck located below the top ring 68 of the first bottle 60a. Therefore, the actuator head will match the size of the bottle, thereby ensuring that the bottle is securely held and not deform the bottle. Likewise, since the size of the actuator head matches the size of the bottle, the grip arms 108 of the bottle gripping finger assembly 102 do not need the vertically oriented leaf springs 32 or any structure for holding the vertically oriented leaf springs 32.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A bottle gripping assembly comprising:
a bottle gripping finger assembly; and
an actuator for actuating the bottle gripping finger assembly for selectively grabbing and releasing a bottle;
the bottle gripping finger assembly including a base with a pair of grip arms rotatably connected to the base, the bottle gripping finger assembly including a biasing element forcing first ends of the grip arms away from each other;
the actuator including an actuator head configured to abut each of the grip arms to force the first ends of the grip arms towards each other against the bias of the biasing element to thereby actuate the bottle gripping finger assembly for selectively grabbing the bottle, wherein the actuator head is configured to be rotated to allow the biasing element to force the first ends of the grip arms away from each other to thereby release the bottle;
wherein the actuator head includes a pair of rollers, each of the rollers configured to abut against the grip arms to force the first ends of the grip arms towards each other against the bias of the biasing element.

2. The bottle gripping assembly of claim 1, wherein:
the grip arms do not include any leaf springs for engaging the actuator head.

3. The bottle gripping assembly of claim 1, wherein:
the actuator further includes a base, the actuator head being configured to be removably connected to the base by a fastener.

4. The bottle gripping assembly of claim 1, wherein:
the actuator head includes a first non-circular periphery and the base has an opening with a second non-circular periphery having the same dimensions as the first non-circular periphery to allow the actuator head to be securely received within the base.

5. The bottle gripping assembly of claim 1, wherein:
the actuator includes a base and the actuator head includes a holder and a pair of rollers, the holder being configured to be removably connected to the base of the actuator.

6. The bottle gripping assembly of claim 5, wherein:
the holder includes a first non-circular periphery and the base has an opening with a second non-circular periphery having the same dimensions as the first non-circular periphery to allow the holder to be securely and non-rotatably received within the base.

7. The bottle gripping assembly of claim 5, wherein:
the holder includes a pair of posts received within the rollers such that the rollers are able to freely rotate about the posts.

8. The bottle gripping assembly of claim 7, wherein:
the actuator head further includes at least one top cap for maintaining the rollers on the posts.

9. The bottle gripping assembly of claim 8, wherein:
the at least one top cap comprises a single top cap extending between and being connected to ends of the pair of posts.

10. The bottle gripping assembly of claim 7, wherein:
the actuator head includes a clip for assisting in maintaining the rollers on each of the posts.

11. The bottle gripping assembly of claim 5, wherein:
the base includes a holding cylinder holding the holder;
the bottle gripping finger assembly includes a receiving cylinder receiving the holding cylinder therein, the receiving cylinder allowing the holding cylinder and therefore the base to rotate relative to the bottle gripping finger assembly.

12. A bottle gripping assembly kit comprising:
a bottle gripping finger assembly; and
an actuator for actuating the bottle gripping finger assembly for selectively grabbing and releasing a bottle;
the bottle gripping finger assembly including a base with a pair of grip arms rotatably connected to the base, the bottle gripping finger assembly including a biasing element forcing first ends of the grip arms away from each other;
the actuator including a plurality of actuator heads and a base, wherein a selected one of the actuator heads can be connected to the base dependent on the size of the bottle;
each of the actuator heads being configured to abut each of the grip arms to force the first ends of the grip arms towards each other against the bias of the biasing element to thereby actuate the bottle gripping finger assembly for selectively grabbing the bottle, wherein each of the actuator heads are also configured to be rotated to allow the biasing element to force the first ends of the grip arms away from each other to thereby release the bottle;
wherein the plurality of actuator heads each have engagement surfaces adapted to abut the grip arms to force the first ends of the grip arms towards each other against the bias of the biasing element;
wherein each of the actuator heads has a distance between the engagement surfaces that is different than a distance between the engagement surfaces of the remaining actuator heads, thereby allowing the selected one of the actuator heads to be selected depending on the size of the bottle.

13. The bottle gripping assembly kit of claim 12, wherein:
each of the actuator heads includes a pair of rollers, each of the rollers configured to abut against the grip arms to force the first ends of the grip arms towards each other against the bias of the biasing element.

14. The bottle gripping assembly kit of claim 12, wherein:
the grip arms do not include any leaf springs for engaging the selected one of the actuator heads.

15. The bottle gripping assembly kit of claim 12, wherein:
the selected one of the actuator heads is configured to be removably connected to the base by a fastener.

16. The bottle gripping assembly kit of claim 12, wherein:
each of the actuator heads includes a first non-circular periphery and the base has an opening with a second non-circular periphery having the same dimensions as the first non-circular periphery to allow the selected one of the actuator heads to be securely received within the base.

17. The bottle gripping assembly kit of claim 12, wherein:
each of the actuator heads includes a holder and a pair of rollers, the holder being configured to be removably connected to the base of the actuator.

18. The bottle gripping assembly kit of claim 17, wherein:
the holder includes a first non-circular periphery and the base has an opening with a second non-circular periphery having the same dimensions as the first non-circular periphery to allow the holder to be securely and non-rotatably received within the base.

19. The bottle gripping assembly kit of claim 17, wherein:
the holder includes a pair of posts received within the rollers such that the rollers are able to freely rotate about the posts.

20. The bottle gripping assembly kit of claim 19, wherein:
each of the actuator heads further includes at least one top cap for maintaining the rollers on the posts.

21. The bottle gripping assembly kit of claim 20, wherein:
the at least one top cap comprises a single top cap extending between and being connected to ends of the pair of posts.

22. The bottle gripping assembly kit of claim 19, wherein:
each of the actuator heads includes a clip for assisting in maintaining the rollers on each of the posts.

23. The bottle gripping assembly kit of claim 17, wherein:
the base includes a holding cylinder holding the holder of the selected one of the actuator heads;
the bottle gripping finger assembly includes a receiving cylinder receiving the holding cylinder therein, the receiving cylinder allowing the holding cylinder and therefore the base to rotate relative to the bottle gripping finger assembly.
